(19) United States
(12) Patent Application Publication
(10) Pub. No.: US 2022/0227358 A1
(43) Pub. Date: Jul. 21, 2022

(54) MAP-BASED TARGET HEADING DISAMBIGUATION

(71) Applicant: GM GLOBAL TECHNOLOGY OPERATIONS LLC, Detroit, MI (US)

(72) Inventors: Yasen Hu, Warren, MI (US); Brent N. Bacchus, Warren, MI (US)

(21) Appl. No.: 17/153,381

(22) Filed: Jan. 20, 2021

(51) Int. Cl. B60W 30/09; G01C 21/00; B60W 10/20; B60W 10/18; B60W 30/095

(52) U.S. Cl. CPC B60W 30/09; G01C 21/3889; G06K 9/00798; B60W 10/18; B60W 30/0956; B60W 10/20

(57) ABSTRACT

A vehicle control system for automated driver-assistance includes a controller that generates a control signal to alter operation of one or more actuators of a vehicle based on a heading of a target. Generating the control signal includes determining a first heading of the target based on sensor data. Further, a probability (pₐ) of the first heading being accurate is computed based on a number of heading flips encountered in a duration-window of a predetermined length. Further, a map-probability (pm) that the target is traveling according to data from a navigation map is computed. Further, a posterior probability (p_{f}) of the first heading being accurate is computed based on the probability (pₐ) and the map-probability (pₘ). Generating the control signal further includes, in response to the posterior probability being less than a predetermined threshold, correcting the first heading, and generating the control signal based on the first heading.

### INTRODUCTION

The subject disclosure relates to autonomous or semi-autonomous vehicle control systems and particularly to estimating the occurrence of 180-degree heading ambiguity in vehicle tracks when performing vehicle control.

Autonomous or semi-autonomous vehicle systems have been developed to aid vehicle operators in driving a vehicle and/or to perform automated operation of the vehicle with little or no operator intervention needed. These systems generally use vehicle sensors and other positional tools to control one or more aspects of vehicle operation. Autonomous and semi-autonomous vehicles make use of sensor information to control one or more components of the vehicle. Sensors such as radars, lidars, and cameras are disposed about the vehicle and sense observable conditions of the environment. In some instances, data obtained from the sensors can be inaccurate. For example, a detected range or a detected heading of an object may be inaccurate due to sensor limitations and/or uneven surface conditions.

Accordingly, it is desirable to provide methods and systems for correcting sensor information. Furthermore, other desirable features and characteristics of the technical solutions described herein will become apparent from the subsequent detailed description and the appended claims, taken in conjunction with the accompanying drawings and the foregoing technical field and background.

### SUMMARY

According to one or more embodiments, a vehicle control system for automated driver-assistance includes a plurality of sensors that capture sensor data of a target. The vehicle control system further includes a controller that generates a control signal to alter operation of one or more actuators of a vehicle based on a heading of the target. Generating the control signal includes determining a first heading of the target based on the sensor data. Generating the control signal further includes computing a probability (pₐ) of the first heading being accurate based on a number of heading flips encountered in a duration-window of a predetermined length. Generating the control signal further includes computing a map-probability (pₘ) that the target is traveling according to data from a navigation map. Generating the control signal further includes computing a posterior probability (p_{f}) of the first heading being accurate based on the probability (pₐ) and the map-probability (pₘ). Generating the control signal further includes, in response to the posterior probability being less than a predetermined threshold, correcting the first heading, and generating the control signal based on the first heading.

In one or more embodiments, correcting the first heading comprises changing the first heading by 180-degrees.

In one or more embodiments, computing the probability (pₐ) of the first heading being accurate comprises computing a heading ambiguity probability (qₐ) as a weighted average of a number of heading jumps in the duration-window, a heading jump representing a change of at least a predetermined amount in successive heading values of the target. The duration-window is of a predetermined length to select the most recent heading values of the target. In one or more embodiments, the weighted average of the number of heading jumps in the duration-window is computed using a decay rate that assigns a higher weight to a more recent values of the heading jump.

In one or more embodiments, prior to computing the map-probability (pₘ), and in response to a heading offset being above a predetermined threshold, the first heading is corrected and the probability (pₐ) of the first heading being accurate is adjusted as pₐ=1−pₐ.

In one or more embodiments, the actuators of the vehicle operate at least one of a steering, a powertrain, and a brake of the vehicle.

According to one or more embodiments, a computer-implemented method for automated driver-assistance by a vehicle control system includes determining a first heading of a target based on sensor data captured by one or more sensors of a host. The computer-implemented method further includes computing a probability (pₐ) of the first heading being accurate based on a number of heading flips encountered in a duration-window of a predetermined length. The computer-implemented method further includes computing a map-probability (pₘ) that the target is traveling according to data from a navigation map. The computer-implemented method further includes computing a posterior probability (p_{f}) of the first heading being accurate based on the probability (pₐ) and the map-probability (pₘ). The computer-implemented method further includes, in response to the posterior probability being less than a predetermined threshold, correcting the first heading. The computer-implemented method further includes generating a control signal based on the first heading, the control signal alters an operation of one or more actuators of the host.

In one or more embodiments, correcting the first heading comprises changing the first heading by 180-degrees.

In one or more embodiments, computing the probability (pₐ) of the first heading being accurate comprises computing a heading ambiguity probability (qₐ) as a weighted average of a number of heading jumps in the duration-window, a heading jump representing a change of at least a predetermined amount in successive heading values of the target. The duration-window is of a predetermined length to select the most recent heading values of the target. In one or more embodiments, the weighted average of the number of heading jumps in the duration-window is computed using a decay rate that assigns a higher weight to a more recent values of the heading jump.

In one or more embodiments, prior to computing the map-probability (pₘ), and in response to a heading offset being above a predetermined threshold, the first heading is corrected and the probability (pₐ) of the first heading being accurate is adjusted as pₐ=1−pₐ.

In one or more embodiments, the actuators of the vehicle operate at least one of a steering, a powertrain, and a brake of the vehicle.

According to one or more embodiments, a vehicle includes a plurality of actuators for controlling operations of the vehicle. The vehicle further includes a vehicle control system for automated driver-assistance. The vehicle control system includes a plurality of sensors that capture sensor data of a target. The vehicle control system further includes a controller that generates a control signal to alter operation of one or more actuators of a vehicle based on a heading of the target. Generating the control signal includes determining a first heading of the target based on the sensor data. Generating the control signal further includes computing a probability (pₐ) of the first heading being accurate based on a number of heading flips encountered in a duration-window of a predetermined length. Generating the control signal further includes computing a map-probability (pₘ) that the target is traveling according to data from a navigation map. Generating the control signal further includes computing a posterior probability (p_{f}) of the first heading being accurate based on the probability (pₐ) and the map-probability (pₘ). Generating the control signal further includes, in response to the posterior probability being less than a predetermined threshold, correcting the first heading, and generating the control signal based on the first heading.

In one or more embodiments, correcting the first heading comprises changing the first heading by 180-degrees.

In one or more embodiments, computing the probability (pₐ) of the first heading being accurate comprises computing a heading ambiguity probability (qₐ) as a weighted average of a number of heading jumps in the duration-window, a heading jump representing a change of at least a predetermined amount in successive heading values of the target. The duration-window is of a predetermined length to select the most recent heading values of the target. In one or more embodiments, the weighted average of the number of heading jumps in the duration-window is computed using a decay rate that assigns a higher weight to a more recent values of the heading jump.

In one or more embodiments, prior to computing the map-probability (pₘ), and in response to a heading offset being above a predetermined threshold, the first heading is corrected and the probability (pₐ) of the first heading being accurate is adjusted as pₐ=1−pₐ.

In one or more embodiments, the actuators of the vehicle operate at least one of a steering, a powertrain, and a brake of the vehicle.

The above features and advantages and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a block diagram of an example scenario of operating a host vehicle using advanced driver-assistance systems according to one or more embodiments;

FIG. 2 depicts a block diagram of a vehicle control system for a host vehicle is depicted according to one or more embodiments;

FIG. 3 depicts a flowchart of a method for a map-based disambiguation of a target according to one or more embodiments;

FIG. 4 depicts example heading data of a target according to one or more embodiments;

FIG. 5 depicts a correction to a vehicle according to one or more embodiments; and

FIG. 6 is a block diagram of a computer system in accordance with an embodiment.

### DETAILED DESCRIPTION

The following description is merely exemplary in nature and is not intended to limit the present disclosure, its application, or uses. It should be understood that throughout the drawings, corresponding reference numerals indicate like or corresponding parts and features. As used herein, the term “module” refers to processing circuitry that may include an application-specific integrated circuit (ASIC), an electronic circuit, a processor (shared, dedicated, or group) and memory that executes one or more software or firmware programs, a combinational logic circuit, and/or other suitable components that provide the described functionality.

In accordance with an exemplary embodiment, described herein are technical solutions for estimating an occurrence of 180-degree heading ambiguity in a perceived heading of a target vehicle (“target”) in a host vehicle's (“host”) perception system. The technical solutions described herein further facilitate reducing the estimated heading ambiguity using a model that incorporates the target's pose relative to a map. The technical solutions described herein ensure that estimates for a target for which the map information is uninformative are not impacted. The estimated disambiguation is then used to control the host by vehicle control systems, such as advanced driver-assistance systems (ADAS).

ADAS are electronic systems that assist drivers in driving and parking functions associated with a vehicle. For example, ADAS can include image processing algorithms and neural networks developed to help distinguish critical objects in a field of view (FOV) of the host (e.g., traffic lights, warning signals, target vehicles, pedestrians, etc.). ADAS further facilitates estimating possible motion of such detected objects in the FOV. Based on such possible motion of the objects, and other surroundings the ADAS facilitates planning a trajectory of the host. The ADAS controls the operations of the host to follow the planned trajectory, for example, by accelerating, steering, braking, trajectory planning, and performing other such controlling of the host. Such operations of capturing sensory data of the surroundings using one or more sensors, analyzing the captured sensory data to plan the trajectory, and controlling the vehicle according to the trajectory are performed continuously to operate the vehicle automatically or semi-automatically.

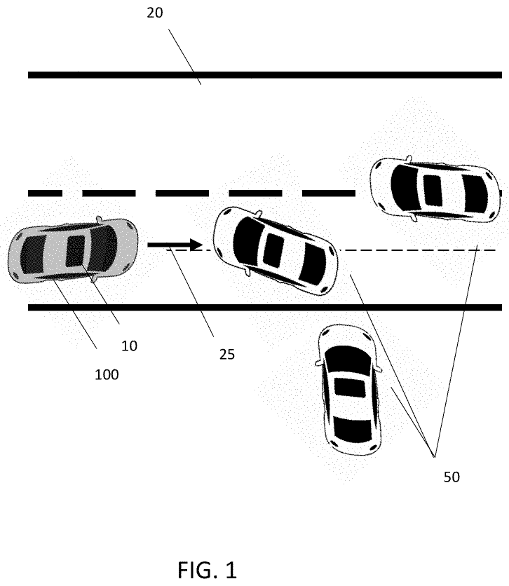

Turning now to FIG. 1, an example scenario of operating a host vehicle using ADAS is depicted. The host vehicle (“host”) 100 is traveling along a road 20 in the direction 25. Here, a direction in which a vehicle is traveling is referred to as a “heading” of that vehicle. Accordingly, in the depicted case of FIG. 1, the direction 25 is the heading of the host 100. Consider that the host 100 is operated using an ADAS 10. The ADAS 10 perceives motion of one or more target vehicles (“targets”) 50. As part of such perception, the ADAS detects and estimates a heading of each target 50.

A technical challenge with existing ADAS is that a 180-degree ambiguity is introduced when estimating the heading of a target, particularly in the case where the target 50 is traveling at a slow speed, which is a speed lower than a predetermined threshold. For example, the threshold can be speed of or below 20 miles per hour (MPH), 15 MPH, 5 MPH, or any other such value. Such slow-moving targets 50 can be encountered in urban/suburban environments, parking lots, traffic jams, or any other such scenarios where the vehicles are typically moving at slow speeds, below the threshold. The ambiguous estimation of the heading of the target 50 results in the ADAS 10 altering the trajectory of the host 100, and in turn, the heading 25 of the host 100. If the trajectory is altered frequently, at least a predetermined number of times per minute (e.g., 3 times, 5 times, 10 times, etc.), the host 100 exhibits an undesirable behavior. If the heading of any of targets 50 is such that they appear to be moving towards the host 100, then the ADAS 10 has to react (e.g., by taking evasive maneuvers). The technical solutions described herein facilitate the ADAS 10 to improve the accuracy of the estimated heading of the targets 50, to avoid potential maneuvers that can be caused by incorrect estimates.

Technical solutions described herein address such technical challenges of 180-degree ambiguity with perceiving the heading of targets 50 using existing techniques. Embodiments of the technical solutions described herein facilitate estimating a probability of an ambiguous heading of the target 50. The probability is determined using the target's heading signal and no additional information. Further, the heading of the targets 50 that are parked or entering the road 20 (e.g., see target 50 shown off the road 20 in FIG. 1) are automatically unaffected by the disambiguation process provided by the technical solutions described herein.

The detected heading of a given target 50 can be written as \hat{∅}=∅30 α.π, where ∅) is the true heading and α ∈{0,1}) is a random variable representing the occurrence of a flipped heading. The statistics of the error in \hat{∅} can be described in terms of the probability of ambiguity q_{α}, where q_{α}=0 indicates that there is no error in \hat{∅} and therefore a=0 while q_{α}=1 indicates that there is complete ambiguity (i.e., P(a=0)=P(a=1)=0.5) and therefore it is completely unknown if the heading is flipped. Embodiments of the present invention facilitate a vehicle control system of the host 100 to report the value of probability q_{α} along with \hat{∅}.

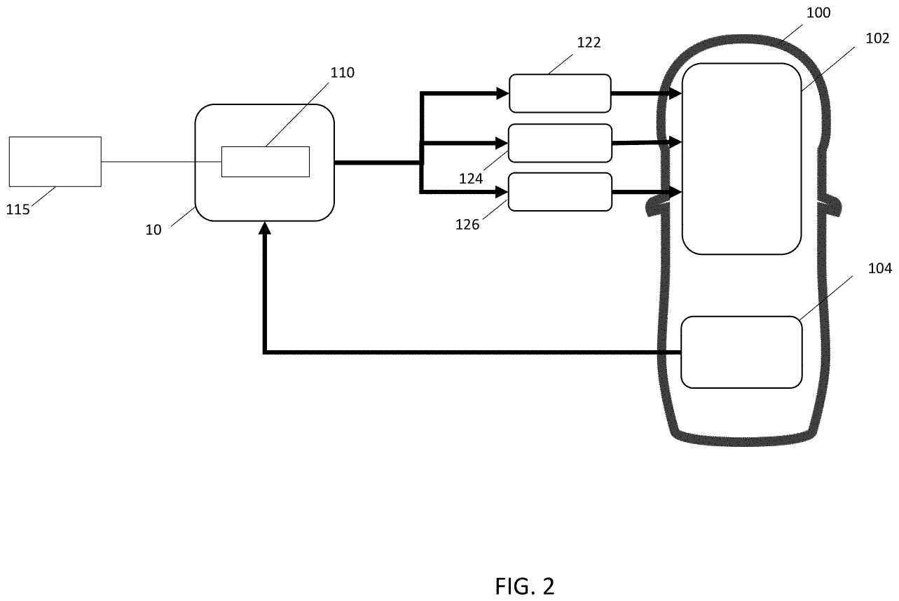

Turning now to FIG. 2, a block diagram of a vehicle control system for a host vehicle is depicted according to one or more embodiments. The host 100 includes a vehicle controller 110 that performs or controls operations to provide functionality of the ADAS 10. The controller 110 can include one or more processors and memory devices. The controller 110 can execute computer-executable instructions to perform one or more methods, such as those described herein.

The controller 110 can send one or more control signals/commands to one or more vehicle operation modules such as steering 122, powertrain 124, brakes 126, etc. The vehicle operation modules can cause a change in the state of one or more vehicle actuators 102 and, in turn, the host 100, in response to such control signals. The vehicle actuators 102 cause a change in physical operation of the host 100, for example, accelerate, decelerate, turn, etc.

The vehicle controller 110 generates the control signals based on one or more inputs from one or more sensors 104 coupled with the host 100. It is to be appreciated that the location of the sensors 104 relative to the host 100, such as front, rear, or side, may be varied in one or more embodiments. The sensors 104 can include various types such as radar, lidar, image sensors, etc.

The vehicle controller 110 can access a navigation map (“map”) 115. The map 115 includes computer readable data that the controller 110 uses to determine the trajectory of the host 100. The map 115 can be stored on a memory device that is local to the ADAS 10, or remote to the ADAS 10. The map 115 includes information about one or more navigable roads that the host 100 can travel.

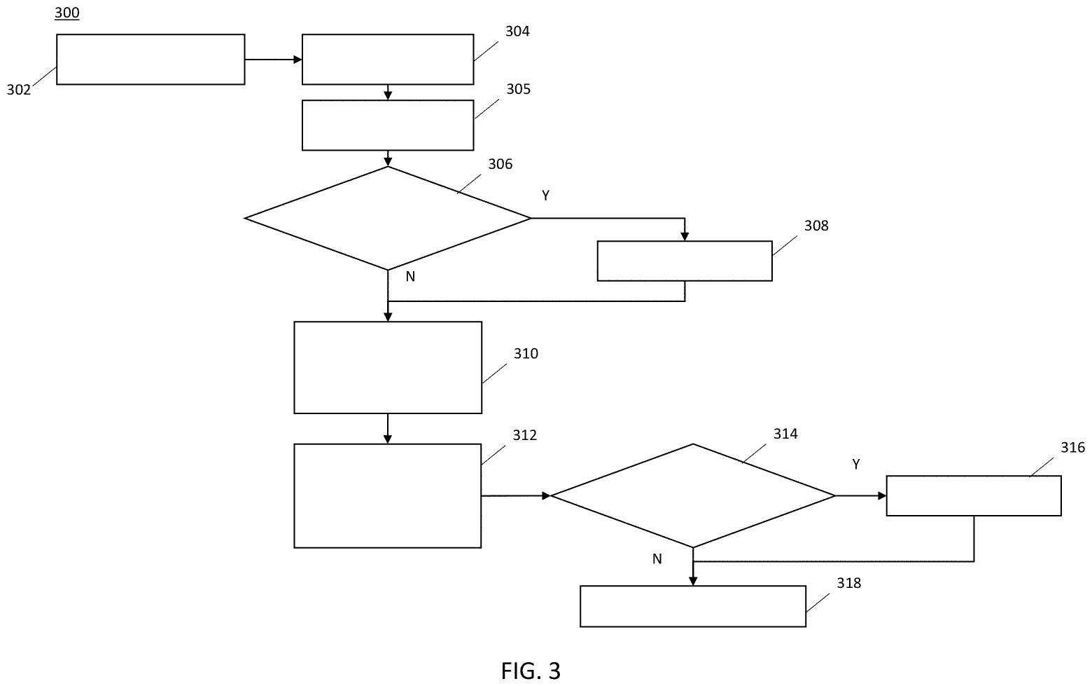

FIG. 3 depicts a flowchart of a method for a map-based disambiguation of a target according to one or more embodiments. The method 300 can be implemented by the controller 110 in one or more embodiments. The method 300 facilitates the ADAS 10 to use the vehicle dynamic states (e.g., lateral distance), and a discrepancy between the perceived heading of the target 50 and the map 115 to parameterize a logistic regression model. The logistic model provides the probability that the heading of the target 50 will align with the map 115 at the present state. Further, the heading ambiguity is reduced by fusing the probability (from the map 115), and a conditional probability (from the sensor data).

It should be noted that while the method 300 is described to be performed for a single target 50, the disambiguation of the heading can be performed for several targets 50 by the host 100. In one or more embodiments, the disambiguation for multiple targets 50 can be performed in parallel.

The method 300 includes computing a heading (∅) of the target 50 based on the measurement data from the one or more sensors 104, at block 302. Computing the heading of the target 50 using measurements from sensors 104 can be performed using any of the known techniques, for example, using camera data, lidar data, radar data, or any other such sensor data. It should be noted that in this case, the sensors 104 are used to monitor the target 50 in the FOV of the host 100.

At block 304, a heading ambiguity probability is computed for the target 50. The heading ambiguity probability is estimated from a rate of 180-degree heading jumps of the target 50 since the target 50 is being monitored by the host 100. A “heading jump” is a 180-degree change in the heading of the target 50. For example, a yaw of the target 50 is used to determine the heading of the target 50. The yaw is monitored by the sensors 104.

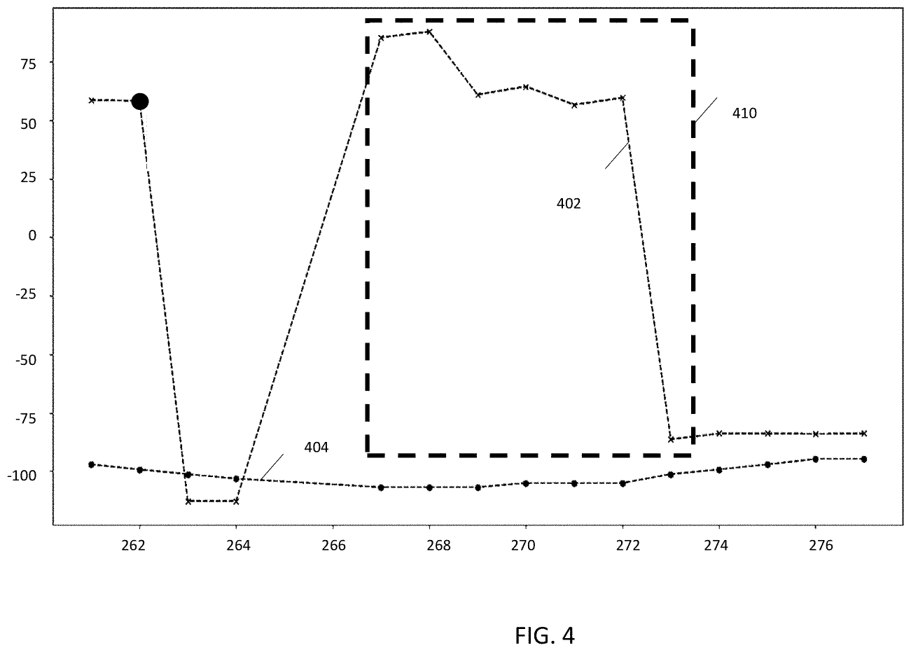

FIG. 4 depicts example heading data of a target according to one or more embodiments. The yaw data includes sensor yaw 402, which is a collection of the yaw of the target 50 monitored by the sensors 104 over a predetermined duration, such as last 2 seconds, 10 seconds, 30 seconds, etc. In one or more embodiments, the sensor yaw 402 is the collection of the monitored yaw of the target 50 since the target 50 was detected in the FOV of the host 100. For example, in FIG. 4, the sensor yaw 402 shows the heading values (∅ᵢ) of the target 50 at timepoints i, where i=262 to 274. It should be noted that i can take other integer values, and that only a subset of the N monitored values of the target 50 is depicted in FIG. 4.

To compute the heading ambiguity probability, for each timepoint i, a jump-indicator (δᵢ) is computed using the heading value (∅ᵢ) as:

δᵢ=I(|∅ᵢ−∅ᵢ₋₁|≈π)

Here, for each pair of successive heading values, a difference is computed, and the difference is compared with a predetermined value, in this case π. In the above equation, I(expr) is an indicator function, which is 1 when expr is true and zero (0) otherwise. It is understood that in other embodiments the predetermined value can be different. If the difference in a pair of successive heading values is within a predetermined threshold from the predetermined value, it is deemed that a heading jump has occurred for the target 50. The number of such heading jumps is determined for the target 50.

In one or more embodiments, the number of heading jumps is determined in a duration-window (W) 410. The duration-window 410 represents a selection of a subset of the N heading values that are monitored for the target 50. The duration-window 410 is of a predetermined length, and can facilitate selecting a predetermined number (w) of most recent heading values.

Further, the heading ambiguity probability (q_{α}) for each timepoint i, is computed as a weighted average of the number of jumps in the duration-window 410 with a decay rate D as follows:

$${q}_{a , i} = \frac{1}{{\sum }_{m = 0}^{W - 1} {e}^{- \frac{m}{D}}} {\sum }_{m = 0}^{W - 1} {δ}_{i - m} {e}^{- \frac{m}{D}}$$

Here, D is a predetermined value representing a decay rate. The decay rate is used to weight more recent values of the heading jumps higher.

Referring back to the flowchart of method 300, at block 305, the heading ambiguity probability (q_{α}) is converted to a conditional probability (p_{α}). The conditional probability represents a probability of getting a correct heading of the target 50, given that the heading of the target 50 aligns with the map 115. p_{α}=P(correct heading of alignment|target heading aligns with map). The conditional probability for a timepoint is computed as: p_{α}=1−q_{α}/2.

Further, the controller 110 performs a heading flip if a heading offset (Δ∅) of the target 50 exceeds a predetermined threshold, at blocks 306 and 308. The heading offset is a difference in the most recent pair of successive heading values. The predetermined threshold used to determine the heading offset can be a constant such as 90-degrees, 100 degrees, or any other such value. Performing the heading flip includes changing the heading value of the target 50 by 180-degrees, ∅′=∅+π, where ∅′ is the resulting heading value when the present value of ∅ is flipped. Further, performing the heading flip includes updating the conditional probability P_{α}=1−p_{α}.

TABLE 1
depicts example values of qₐ and pₐ:

| qₐ | pₐ |
|---|---|
| 1.0 | 0.5 |
| 0.6 | 0.7 |
| 0.6 (with heading flip) | 0.3 |
| 0 | 1 |

The method 300 further includes computing a map-alignment prior probability, or map-probability, (pₘ), at block 310. Besides the heading information from perception based on the sensors 104, the map 115 provides another source of heading information given that the target 50 follows the legally permitted direction of lane of travel according to the data from the map 115. Accordingly, the map-alignment prior probability (pₘ) provides that the target 50 is aligned with the direction of its associated lane in the map 115. Such an alignment depends on at least a lateral distance (d), and a heading difference (∈) between the direction of a nominal path and the heading of the target 50 from the sensor data.

The lateral distance (d) is a distance between the target 50 from a center of a lane in the road 20. The information for the center of the lane in the road 20 can be determined from the map 115, in one or more embodiments. Alternatively, or in addition, the center of the lane can be determined using the sensors 104. For example, the sensors 104 can capture images of the road 20, from which, using image processing algorithms, one or more lane markings can be detected. Using the lane markings, a center of the lane can be computed.

The heading difference (∈) between the direction of a nominal path and the heading of the target 50 can be computed using the map 115 and the present heading value of the target 50. The nominal path is shown in FIG. 4 as the map data 404. At each timepoint, the map data 404 indicates an estimated direction, heading, of the target 50 based on the map 115.

For example, based on the map 115, the position of the host 100, and a relative position of the target 50 from the host 100, the controller 110 can estimate a direction of travel of the target 50. For example, if the target 50 is in the same lane as the host 100, the controller 110 can estimate that the target 50 is traveling in the same direction as the host 100. Alternatively, if the target 50 is laterally offset in a first direction (e.g., left) from the host 100, and if the map 115 indicates that the host 100 is in an extreme lane in that first direction of the road 20 (i.e., left-most lane), the controller 110 can estimate that the target 50 is in another lane that is traveling in the opposite direction as the host 100. It is understood that above are examples, and that various other examples are possible based on the data in the map 115, the geographic location, and the travel regulations in such geographies, among other factors.

In one or more embodiments, the map-alignment prior probability is assumed to be computed using a logistic model. The computation can be performed using an expression such as:

$${p}_{m} ( d , ϵ ) = \frac{1}{2} ( 1 + \frac{1}{1 + {e}^{- ( {a}_{0} + {a}_{1} d + {a}_{2} \vert cos ϵ \vert )}} )$$

Here, a₀, a₁, and a₂ are predetermined constants. In one or more embodiments, collected training data is utilized as ground truth, and fit it into a logistic regression model to estimate the parameters a₀, a₁, a₂. Using the above expression, it is expected that the map 115 is informative and pₘ≈1, when lateral distance and heading offset are small (less than a predetermined threshold).

The method 300 further includes computing a posterior probability (p_{f}), at block 312. In one or more embodiments, the posterior probability of the target aligning with the map 115 can be computed using Bayes rule:

$${p}_{f} = \frac{{p}_{a} {p}_{m}}{{p}_{a} {p}_{m} + ( 1 - {p}_{a} ) ( 1 - {p}_{m} )}$$

If the posterior probability is less than a threshold, for example 0.5, a heading flip is performed to correct the heading of the target 50, at blocks 314, 316. The heading flip, as described earlier, changes the heading value of the target 50 by adding 180-degrees: ∅=∅+π. In addition, during this second heading flip, the posterior probability value is updated as p_{f}=1−p_{f}.

The posterior ambiguity probability and the heading are output by the controller 110, at block 318. The result is the most likely heading and the corresponding posterior ambiguity probability. In one or more embodiments, a posterior ambiguity probability (q_{f}) is computed as q_{f}=2(1−p_{α}). The ADAS 10 uses the heading to generate a control signal to alter the operation(s) of the actuators 102 of the host 100, resulting in a change in trajectory/operation of the host 100. In one or more embodiments, the posterior ambiguity probability can be used by other functions of the ADAS 10, for example, to determine how much weight to give to the heading value of the target 50.

As can be seen from the flowchart of the method 300, in some cases, the heading flip is performed twice depending on the heading offset and the posterior probability values.

It should be noted that the method 300 is performed in parallel for several targets 50 in the FOV of the host 100.

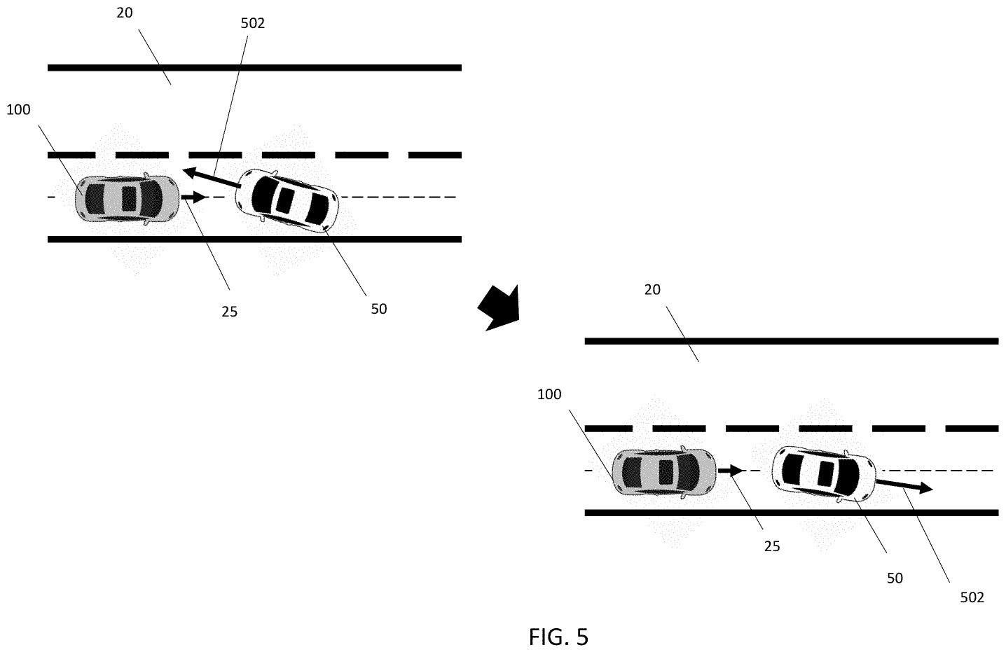

FIG. 5 depicts an example scenario correcting a heading of a target, according to one or more embodiments. In the example, the heading 502 of the target 50 is corrected by performing the method 300, the correction resulting in the heading 502 that was estimated from the sensor data being flipped by 180-degrees.

The technical solutions facilitate practical application to improve the performance of ADAS systems in vehicles by reducing the cost of capturing high-resolution, wide FOV images to implement one or more applications of the ADAS.

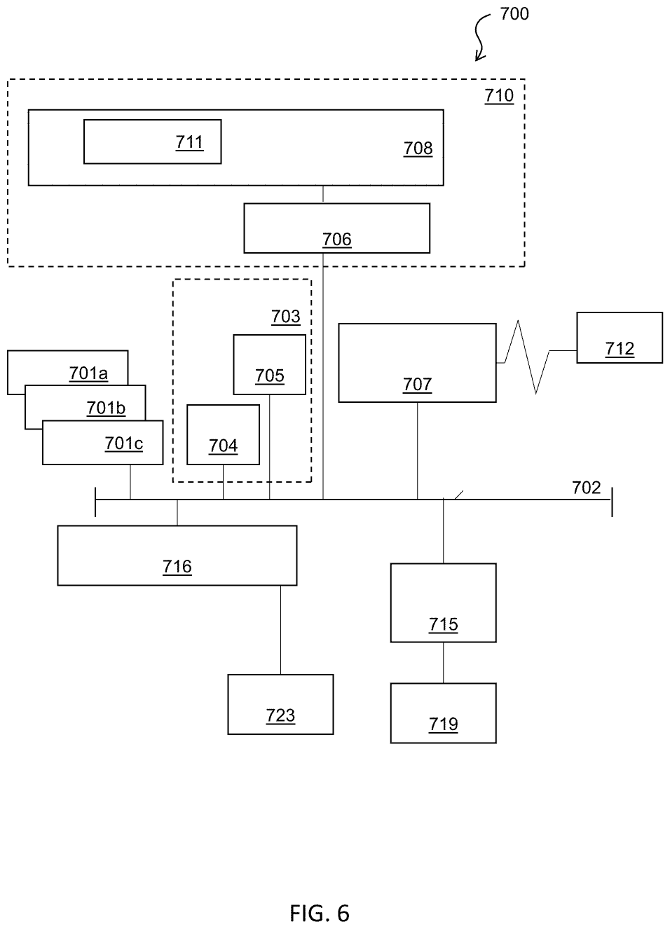

Turning now to FIG. 6, a computer system 700 is generally shown in accordance with an embodiment. The computer system 700 can be an electronic, computer framework comprising and/or employing any number and combination of computing devices and networks utilizing various communication technologies, as described herein. The computer system 700 can be easily scalable, extensible, and modular, with the ability to change to different services or reconfigure some features independently of others. The computer system 700 may be, for example, a server, desktop computer, laptop computer, tablet computer, or smartphone. In some examples, computer system 700 may be a cloud computing node. Computer system 700 may be described in the general context of computer system executable instructions, such as program modules, being executed by a computer system. Generally, program modules may include routines, programs, objects, components, logic, data structures, and so on that perform particular tasks or implement particular abstract data types. Computer system 700 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system 700 has one or more central processing units (CPU(s)) 701a, 701b, 701c, etc. (collectively or generically referred to as processor(s) 701). The processors 701 can be a single-core processor, multi-core processor, computing cluster, or any number of other configurations. The processors 701, also referred to as processing circuits, are coupled via a system bus 702 to a system memory 703 and various other components. The system memory 703 can include a read only memory (ROM) 704 and a random access memory (RAM) 705. The ROM 704 is coupled to the system bus 702 and may include a basic input/output system (BIOS), which controls certain basic functions of the computer system 700. The RAM is read-write memory coupled to the system bus 702 for use by the processors 701. The system memory 703 provides temporary memory space for operations of said instructions during operation. The system memory 703 can include random access memory (RAM), read only memory, flash memory, or any other suitable memory systems.

The computer system 700 comprises an input/output (I/O) adapter 706 and a communications adapter 707 coupled to the system bus 702. The I/O adapter 706 may be a small computer system interface (SCSI) adapter that communicates with a hard disk 708 and/or any other similar component. The I/O adapter 706 and the hard disk 708 are collectively referred to herein as a mass storage 710.

Software 711 for execution on the computer system 700 may be stored in the mass storage 710. The mass storage 710 is an example of a tangible storage medium readable by the processors 701, where the software 711 is stored as instructions for execution by the processors 701 to cause the computer system 700 to operate, such as is described herein with respect to the various Figures. Examples of computer program product and the execution of such instruction is discussed herein in more detail. The communications adapter 707 interconnects the system bus 702 with a network 712, which may be an outside network, enabling the computer system 700 to communicate with other such systems. In one embodiment, a portion of the system memory 703 and the mass storage 710 collectively store an operating system, which may be any appropriate operating system to coordinate the functions of the various components shown in FIG. 7.

Additional input/output devices are shown as connected to the system bus 702 via a display adapter 715 and an interface adapter 716. In one embodiment, the adapters 706, 707, 715, and 716 may be connected to one or more I/O buses that are connected to the system bus 702 via an intermediate bus bridge (not shown). A display 719 (e.g., a screen or a display monitor) is connected to the system bus 702 by display adapter 715, which may include a graphics controller to improve the performance of graphics intensive applications and a video controller. A keyboard, a mouse, a touchscreen, one or more buttons, a speaker, etc. can be interconnected to the system bus 702 via the interface adapter 716, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 7, the computer system 700 includes processing capability in the form of the processors 701, and, storage capability including the system memory 703 and the mass storage 710, input means such as the buttons, touchscreen, and output capability including a speaker 723 and the display 719.

In some embodiments, the communications adapter 707 can transmit data using any suitable interface or protocol, such as the internet small computer system interface, among others. The network 712 may be a cellular network, a radio network, a wide area network (WAN), a local area network (LAN), or the Internet, among others. An external computing device may connect to the computer system 700 through the network 712. In some examples, an external computing device may be an external webserver or a cloud computing node.

It is to be understood that the block diagram of FIG. 7 is not intended to indicate that the computer system 700 is to include all of the components shown in FIG. 7. Rather, the computer system 700 can include any appropriate fewer or additional components not illustrated in FIG. 7 (e.g., additional memory components, embedded controllers, modules, additional network interfaces, etc.). Further, the embodiments described herein with respect to computer system 700 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

It should be understood that one or more steps within a method or process may be executed in a different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed but will include all embodiments falling within the scope thereof.

What is claimed is:

1. A vehicle control system for automated driver-assistance, the vehicle control system comprising:
a plurality of sensors that capture sensor data of a target; and
a controller that generates a control signal to alter operation of one or more actuators of a vehicle based on a heading of the target, wherein generating the control signal comprises:
determining a first heading of the target based on the sensor data;
computing a probability (pₐ) of the first heading being accurate based on a number of heading flips encountered in a duration-window of a predetermined length;
computing a map-probability (pₘ) that the target is traveling according to data from a navigation map;
computing a posterior probability (p_{f}) of the first heading being accurate based on the probability (pₐ) and the map-probability (pₘ);
in response to the posterior probability being less than a predetermined threshold, correcting the first heading; and
generating the control signal based on the first heading.

2. The vehicle control system of claim 1, wherein correcting the first heading comprises changing the first heading by 180-degrees.

3. The vehicle control system of claim 1, wherein computing the probability (pₐ) of the first heading being accurate comprises computing a heading ambiguity probability (qₐ) as a weighted average of a number of heading jumps in the duration-window, a heading jump representing a change of at least a predetermined amount in successive heading values of the target.

4. The vehicle control system of claim 3, wherein the duration-window is of a predetermined length to select the most recent heading values of the target.

5. The vehicle control system of claim 3, wherein the weighted average of the number of heading jumps in the duration-window is computed using a decay rate that assigns a higher weight to a more recent values of the heading jump.

6. The vehicle control system of claim 1, wherein, prior to computing the map-probability (pₘ), and in response to a heading offset being above a predetermined threshold, the first heading is corrected and the probability (pₐ) of the first heading being accurate is adjusted as pₐ=1−pₐ.

7. The vehicle control system of claim 1, wherein the actuators of the vehicle operate at least one of a steering, a powertrain, and a brake of the vehicle.

8. A computer-implemented method for automated driver-assistance by a vehicle control system, wherein the computer-implemented method comprises:
determining a first heading of a target based on sensor data captured by one or more sensors of a host;
computing a probability (pₐ) of the first heading being accurate based on a number of heading flips encountered in a duration-window of a predetermined length;
computing a map-probability (pₘ) that the target is traveling according to data from a navigation map;
computing a posterior probability (p_{f}) of the first heading being accurate based on the probability (pₐ) and the map-probability (pₘ);
in response to the posterior probability being less than a predetermined threshold, correcting the first heading; and
generating a control signal based on the first heading, the control signal alters an operation of one or more actuators of the host.

9. The method of claim 8, wherein correcting the first heading comprises changing the first heading by 180-degrees.

10. The method of claim 8, wherein computing the probability (pₐ) of the first heading being accurate comprises computing a heading ambiguity probability (qₐ) as a weighted average of a number of heading jumps in the duration-window, a heading jump representing a change of at least a predetermined amount in successive heading values of the target.

11. The method of claim 10, wherein the duration-window is of a predetermined length to select the most recent heading values of the target.

12. The method of claim 10, wherein the weighted average of the number of heading jumps in the duration-window is computed using a decay rate that assigns a higher weight to a more recent value of the heading jump.

13. The method of claim 8, wherein, prior to computing the map-probability (pₘ), and in response to a heading offset being above a predetermined threshold, the first heading is corrected and the probability (pₐ) of the first heading being accurate is adjusted as pₐ=1−pₐ.

14. The method of claim 8, wherein the actuators of the host operate at least one of a steering, a powertrain, and a brake of the host.

15. A vehicle comprising:
a plurality of actuators for controlling operations of the vehicle; and
a vehicle control system for automated driver-assistance, wherein the vehicle control system comprises:
a plurality of sensors that capture sensor data of a target; and
a controller that generates a control signal to alter operation of one or more actuators of a vehicle based on a heading of the target, wherein generating the control signal comprises:
determining a first heading of the target based on the sensor data;
computing a probability (pₐ) of the first heading being accurate based on a number of heading flips encountered in a duration-window of a predetermined length;
computing a map-probability (pₘ) that the target is traveling according to data from a navigation map;
computing a posterior probability (p_{f}) of the first heading being accurate based on the probability (pₐ) and the map-probability (pₘ);
in response to the posterior probability being less than a predetermined threshold, correcting the first heading; and
generating the control signal based on the first heading.

16. The vehicle of claim 15, wherein correcting the first heading comprises changing the first heading by 180-degrees.

17. The vehicle of claim 15, wherein computing the probability (pₐ) of the first heading being accurate comprises computing a heading ambiguity probability (qₐ) as a weighted average of a number of heading jumps in the duration-window, a heading jump representing a change of at least a predetermined amount in successive heading values of the target.

18. The vehicle of claim 17, wherein the duration-window is of a predetermined length to select the most recent heading values of the target.

19. The vehicle of claim 17, wherein the weighted average of the number of heading jumps in the duration-window is computed using a decay rate that assigns a higher weight to a more recent value of the heading jump.

20. The vehicle of claim 15, wherein, prior to computing the map-probability (μm), and in response to a heading offset being above a predetermined threshold, the first heading is corrected and the probability (pₐ) of the first heading being accurate is adjusted as pₐ=1−pₐ.
